(19) United States
(12) Patent Application Publication
(10) Pub. No.: US 2026/0027808 A1
(43) Pub. Date: Jan. 29, 2026

(54) MULTILAYER POLYIMIDE FILM AND METAL-CLAD LAMINATE SHEET

(71) Applicant: KANEKA CORPORATION, Osaka (JP)

(72) Inventors: Junpei Saito, Otsu-shi (JP); Takayuki Watanabe, Otsu-shi (JP); Yuichi Imamura, Otsu-shi (JP); Teppei Shimazaki, Otsu-shi (JP)

(73) Assignee: KANEKA CORPORATION, Osaka (JP)

(21) Appl. No.: 19/342,415

(22) Filed: Sep. 26, 2025

Related U.S. Application Data
(63) Continuation of application No. PCT/JP2024/009931, filed on Mar. 14, 2024.

(30) Foreign Application Priority Data
Mar. 29, 2023 (JP) 2023-052954

(51) Int. Cl. B32B 15/08; B29C 41/00; B29C 41/22; B29C 41/46; B29K 79/00; B29L 7/00; B29L 9/00; B32B 15/20

(52) U.S. Cl. CPC B32B 15/08; B29C 41/003; B29C 41/22; B29C 41/46; B32B 15/20; B29K 2079/085; B29L 2007/008; B29L 2009/00; B32B 2250/40; B32B 2307/54; B32B 2307/7376

(57) ABSTRACT

A multi-layered polyimide film includes a non-thermoplastic polyimide layer and at least one thermoplastic polyimide layer disposed on at least one surface of the non-thermoplastic polyimide layer. A non-thermoplastic polyimide contained in the non-thermoplastic polyimide layer has a tetracarboxylic dianhydride residue including a benzophenone skeleton, as a tetracarboxylic dianhydride residue, and has a diamine residue including a biphenyl skeleton, as a diamine residue. In the multi-layered polyimide film, the content rate of the diamine residue including a biphenyl skeleton in the non-thermoplastic polyimide is 30 mol % or more and 100 mol % or less with respect to all of diamine residues included in the non-thermoplastic polyimide.

### TECHNICAL FIELD

One or more embodiments of the present invention relate to a multi-layered polyimide film and a metal-clad laminate.

### BACKGROUND

In recent years, demand for flexible printed circuit boards (hereinafter, sometimes referred to as “FPCs”) has been growing with an expansion of demand for electronic products mainly including smartphones, tablet personal computers, notebook personal computers, and the like. Among them, FPCs in which a multi-layered polyimide film including a thermoplastic polyimide layer as an adhesive layer is used as a material are excellent in heat resistance and flexibility, and therefore further growth of demand for these FPCs is expected. For electronic devices, reduction in weight, size, and thickness has been recently advanced. Thus, there is still a strong demand for finer-pitch FPC wiring.

In preparation of a fine-pitch double-sided FPC or a multilayer FPC, a metal-clad laminate, which is obtained by bonding a metal foil such as a copper foil to both surfaces of a polyimide film to be a substrate, is generally used as a material. In production of an FPC, a step is first performed in which a hole (hereinafter, sometimes referred to as “via”) is opened for electrically connecting layers. The inner wall of the via is plated, and thus both surfaces of the circuit board can be electrically connected. Methods of the via forming step include a through-hole method in which a through-hole is opened in metal foils on both surfaces and an insulating layer (polyimide layer) with a drill or a laser, and a blind via method in which a metal foil on one surface and an insulating layer are cut with a laser or the like and a metal foil on the other surface is left. The blind via method is frequently used particularly for a fine-pitch FPC in order to effectively use the area.

Conventionally, such a via forming step includes a wet desmear treatment (hereinafter, sometimes simply referred to as “desmear treatment”) in which a laminate is treated with an alkaline potassium permanganate aqueous solution or the like while heated after opening the hole in order to clean the inside of the hole and the metal foil surface or to remove the resin residue. A polyimide is easily hydrolyzed under an alkaline condition, and therefore the desmear treatment tends to reduce the film strength. Reduction in film strength may cause a defect such as a crack or a tear in the polyimide film (that is, a substrate of an FPC) after the desmear treatment.

For the purpose of improving productivity, the process of producing an FPC is changing from a conventional batch type process (discontinuous process) to a roll-to-roll type process (continuous process). In the roll-to-roll type process, cost reduction can be expected, but if the treatment time is long in some steps, the treatment time of the entire process becomes also long, and as a result, the thermal load applied to a substrate tends to be large. Furthermore, the roll-to-roll type process requires applying a tension to a substrate for the purpose of preventing generation of creases during conveyance of the substrate, and therefore the mechanical load on the substrate tends to be larger in the roll-to-roll type process than in the batch type process. Thus, in the roll-to-roll type process, reduction in film strength due to the desmear treatment is likely to be apparent.

A method has been conventionally reported in which a heat treatment step is added between laser processing and a desmear treatment to remove the residual stress generated by the laser processing and thus suppress a crack (for example, Patent Document 1). A method has been also reported in which a crack is suppressed by a polyimide laminate film in which a polyimide aggregate structure is controlled (for example, Patent Document 2).

### PATENT DOCUMENTS

Patent Document 1: Japanese Patent Application Laid-Open Publication No. 2012-186377
Patent Document 2: Japanese Patent Application Laid-Open Publication No. 2017-177604

### SUMMARY

However, in the techniques disclosed in Patent Documents 1 and 2, there remains room for improvement for suppressing reduction in film strength caused by the desmear treatment.

One or more embodiments of the present invention have been made in view of the above, and a multi-layered polyimide film capable of suppressing reduction in film strength caused by a desmear treatment, and a metal-clad laminate using the multi-layered polyimide film are provided.

### Aspects of One or More Embodiments of the Invention

An aspect of one or more embodiments of the present invention is as follows.
[1] A multi-layered polyimide film including:
a non-thermoplastic polyimide layer; and
a thermoplastic polyimide layer disposed on at least one surface of the non-thermoplastic polyimide layer,
the non-thermoplastic polyimide layer containing a non-thermoplastic polyimide having a tetracarboxylic dianhydride residue including a benzophenone skeleton, as a tetracarboxylic dianhydride residue, the non-thermoplastic polyimide having a diamine residue including a biphenyl skeleton, as a diamine residue,
the multi-layered polyimide film having a content rate of the diamine residue including a biphenyl skeleton of 30 mol % or more and 100 mol % or less with respect to all of diamine residues included in the non-thermoplastic polyimide.
[2] The multi-layered polyimide film according to [1], having a content rate of the tetracarboxylic dianhydride residue including a benzophenone skeleton of 30 mol % or more and 100 mol % or less with respect to all of tetracarboxylic dianhydride residues included in the non-thermoplastic polyimide.
[3] The multi-layered polyimide film according to [1] or [2], having a strain retention rate of 80% or more after the non-thermoplastic polyimide layer is subjected to a desmear treatment under conditions of a treatment temperature of 70° C. and a treatment time of 5 minutes.
[4] The multi-layered polyimide film according to any one of [1] to [3], in which the non-thermoplastic polyimide layer at 10% strain has a tensile stress of 220 MPa or more.
[5] The multi-layered polyimide film according to any one of [1] to [4], in which the non-thermoplastic polyimide layer has a linear thermal expansion coefficient of 5.0 ppm/K or more and 19.0 ppm/K or less.
[6] A metal-clad laminate including:
the multi-layered polyimide film according to any one of [1] to [5]; and
a metal layer disposed on a main surface of at least one of the thermoplastic polyimide layer of the multi-layered polyimide film.

According to one or more embodiments of the present invention, it is possible to provide a multi-layered polyimide film capable of suppressing reduction in film strength caused by a desmear treatment, and a metal-clad laminate using the multi-layered polyimide film.

### BRIEF DESCRIPTION OF THE DRAWINGS

FIG. 1 is a sectional view showing an example of a multi-layered polyimide film according to one or more embodiments of the present invention.

FIG. 2 is a sectional view showing an example of a metal-clad laminate according to one or more embodiments of the present invention.

### DETAILED DESCRIPTION

One or more embodiments of the present invention will be described in detail below, but one or more embodiments of the present invention are not limited to these embodiments. The academic documents and the patent documents mentioned in the present description are incorporated in the present description by reference in their entirety.

First, terms used in the present description will be described. The term “structural unit” refers to a repeating unit included in a polymer. The term “polyimide” refers to a polymer including a structural unit represented by the following general formula (1) (hereinafter, sometimes referred to as “structural unit (1)”).

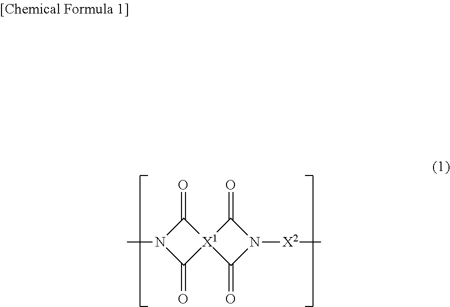

In the general formula (1), X¹ represents a tetracarboxylic dianhydride residue (tetravalent organic group derived from a tetracarboxylic dianhydride), and X² represents a diamine residue (divalent organic group derived from a diamine).

The content rate of the structural unit (1) with respect to all of the structural units included in the polyimide may be, for example, 50 mol % or more and 100 mol % or less, 60 mol % or more and 100 mol % or less, 70 mol % or more and 100 mol % or less, 80 mol % or more and 100 mol % or less, or 90 mol % or more and 100 mol % or less, and may be 100 mol %.

The term “polyamic acid” refers to a polymer including a structural unit represented by the following general formula (2) (hereinafter, sometimes referred to as “structural unit (2)”).

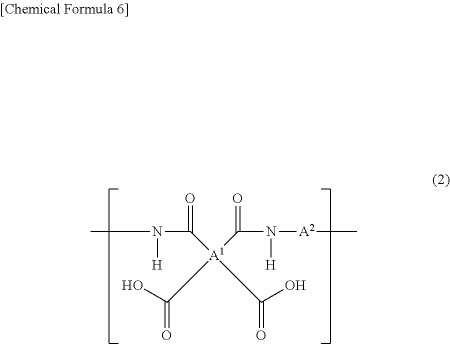

In the general formula (2), A¹ represents a tetracarboxylic dianhydride residue (tetravalent organic group derived from a tetracarboxylic dianhydride), and A² represents a diamine residue (divalent organic group derived from a diamine).

The content rate of the structural unit (2) with respect to all of the structural units included in the polyamic acid may be, for example, 50 mol % or more and 100 mol % or less, 60 mol % or more and 100 mol % or less, 70 mol % or more and 100 mol % or less, 80 mol % or more and 100 mol % or less, or 90 mol % or more and 100 mol % or less, and may be 100 mol %.

A polyimide is an imidized product of a polyamic acid. Therefore, in a case where the content rate of the structural unit (2) with respect to all of the structural units included in the polyamic acid is 100 mol %, a polyimide that is an imidized product of the polyamic acid has a residue represented by A¹ in the general formula (2) as X¹ in the general formula (1), and a residue represented by A² in the general formula (2) as X² in the general formula (1).

The term “linear thermal expansion coefficient” refers to a coefficient of linear thermal expansion during temperature rise from 50° C. to 250° C. unless otherwise specified. The method of measuring the linear thermal expansion coefficient is the same as or similar to the method in Examples described below.

The term “non-thermoplastic polyimide” refers to a polyimide that retains a film shape (flat film shape) without being creased and stretched when fixed in a state of a film (thickness: 17.0 μm) to a metallic fixation frame and heated under a condition at a heating temperature of 450° C. for 2 minutes. The term “thermoplastic polyimide” refers to a polyimide that does not retain a film shape when fixed in a state of a film (thickness: 17.0 μm) to a metallic fixation frame and heated under a condition at a heating temperature of 450° C. for 2 minutes. In the present description, the non-thermoplastic polyimide contained in the non-thermoplastic polyimide layer may be simply referred to as “non-thermoplastic polyimide”. The thermoplastic polyimide contained in the thermoplastic polyimide layer may be simply referred to as “thermoplastic polyimide”.

The term “main surface” of a layered material (more specifically, non-thermoplastic polyimide layer, thermoplastic polyimide layer, multi-layered polyimide film, or the like) refers to a surface orthogonal to the thickness direction of the layered material.

The term “benzophenone skeleton” refers to a skeleton having a bicyclic structure in which two benzene rings are connected by a carbonyl group.

The term “biphenyl skeleton” refers to a skeleton having a bicyclic structure in which two benzene rings are connected by one single bond. Therefore, diamine residues including a biphenyl skeleton do not include diamine residues having a fused ring, such as a 9,9-bis(4-aminophenyl) fluorene residue.

The “physical properties of the non-thermoplastic polyimide layer (such as the tensile modulus, the tensile stress at 10% strain, the inclination of the plastic deformation region, the linear thermal expansion coefficient, and the strain retention rate)” are physical properties of a non-thermoplastic polyimide film having the same composition and the same thickness as the non-thermoplastic polyimide layer. The method of measuring the physical properties of the non-thermoplastic polyimide film is the same as or similar to the method in Examples described below.

Hereinafter, the name of a compound may be followed by the term “-based” to collectively refer to the compound and its derivatives. The term “-based” following the name of a compound to express the name of a polymer means that repeating units of the polymer are derived from the compound or its derivative, unless otherwise specified. A tetracarboxylic dianhydride may be referred to as “acid dianhydride”.

Unless otherwise specified, the components, the functional groups, and the like shown in the present description may be used singly, or in combination of two or more kinds thereof.

In the drawings that are referred to in the following description, the constituent elements are schematically shown for easy understanding, and the size, the number, the shape, and the like of each illustrated constituent element may be different from the actual counterparts for convenience of preparing the drawings. For convenience of description, in the drawings described below, the same constituent part as in a previously described drawing will be given the same reference sign as in the previously described drawing, and the description of the constituent part may be omitted.

### First Embodiment: Multi-Layered Polyimide Film

A multi-layered polyimide film according to a first embodiment of the present invention is a laminate including a non-thermoplastic polyimide layer and a thermoplastic polyimide layer disposed on at least one surface (one main surface) of the non-thermoplastic polyimide layer. A non-thermoplastic polyimide contained in the non-thermoplastic polyimide layer has a tetracarboxylic dianhydride residue including a benzophenone skeleton, as a tetracarboxylic dianhydride residue, and has a diamine residue including a biphenyl skeleton, as a diamine residue. In the first embodiment, the content rate of the diamine residue including a biphenyl skeleton in the non-thermoplastic polyimide is 30 mol % or more and 100 mol % or less with respect to all of diamine residues included in the non-thermoplastic polyimide.

Hereinafter, a tetracarboxylic dianhydride including a benzophenone skeleton may be referred to as “BENDA”. A diamine including a biphenyl skeleton may be referred to as “BPDI”.

The multi-layered polyimide film according to the first embodiment can suppress reduction in film strength caused by a desmear treatment. The reason for this is presumed as follows.

In the multi-layered polyimide film according to the first embodiment, the non-thermoplastic polyimide has a BENDA residue and a BPDI residue each including a skeleton having a high degree of free rotation, and thus entanglement of the polyimide molecular chain is promoted. Meanwhile, a polyimide having a BENDA residue generally exhibits low elasticity and a high linear thermal expansion coefficient because of the above-described high degree of free rotation. However, in the first embodiment, the BPDI residue, which has relatively high linearity, is incorporated into the molecular chain, and the content rate of the BPDI residue is set to 30 mol % or more and 100 mol % or less with respect to all of the diamine residues included in the non-thermoplastic polyimide, and thus the rigidity of the polyimide molecular chain can be secured while entanglement of the polyimide molecular chain is promoted. As a result, the multi-layered polyimide film according to the first embodiment can maintain high film strength (tensile modulus, tensile elongation, and the like) even after a desmear treatment. Therefore, the multi-layered polyimide film according to the first embodiment can suppress reduction in film strength caused by a desmear treatment.

In the first embodiment, in order to further suppress reduction in film strength caused by a desmear treatment, the content rate of the BPDI residue in the non-thermoplastic polyimide may be 30 mol % or more and 80 mol % or less, 30 mol % or more and 70 mol % or less, 30 mol % or more and 60 mol % or less, or 30 mol % or more and 50 mol % or less with respect to all of the diamine residues included in the non-thermoplastic polyimide.

In the first embodiment, in order to further suppress reduction in film strength caused by a desmear treatment, the content rate of the BENDA residue in the non-thermoplastic polyimide may be mol % or more and 100 mol % or less, 30 mol % or more and 70 mol % or less, or 30 mol % or more and 50 mol % or less with respect to all of tetracarboxylic dianhydride residues included in the non-thermoplastic polyimide.

Hereinafter, the property of being capable of suppressing reduction in film strength caused by a desmear treatment may be referred to as “desmear liquid resistance”. As an index of the desmear liquid resistance, the retention rate of the breaking strain of the film after a desmear treatment with respect to the breaking strain (strain at the time of breaking) of the film before the desmear treatment can be used. Hereinafter, the retention rate of the breaking strain of the film after a desmear treatment with respect to the breaking strain of the film before the desmear treatment may be referred to as “strain retention rate”. In order to obtain a multi-layered polyimide film excellent in desmear liquid resistance, the multi-layered polyimide film may have a strain retention rate of 80% or more after the non-thermoplastic polyimide layer is subjected to a desmear treatment under conditions of a treatment temperature of 70° C. and a treatment time of 5 minutes. In the case of adopting a desmear treatment method in which a swelling step, a roughening step, and a neutralization step described below are performed in order, the “treatment temperature” and the “treatment time” of the desmear treatment are the “treatment temperature” and the “treatment time” in the roughening step, respectively.

In order to suppress film deformation in a process of producing a metal-clad laminate, the non-thermoplastic polyimide layer at 10% strain may have a tensile stress of 220 MPa or more, or 240 MPa or more. In order to reduce residual strain at the time of forming a metal-clad laminate, the non-thermoplastic polyimide layer at 10% strain may have a tensile stress of 320 MPa or less, or 310 MPa or less. Hereinafter, the tensile stress at 10% strain may be referred to as “stress at 10% strain”. The stress at 10% strain can be adjusted, for example, by changing the content rate of a residue derived from a monomer having a rigid structure (more specifically, a BPDI residue or the like).

The non-thermoplastic polyimide layer may have an inclination of the plastic deformation region in the stress-strain curve of 2.0 or more. A non-thermoplastic polyimide layer that is less likely to plastically deform and has high yield strength exhibits high durability against a tear in an alkaline environment. In a stress-strain curve in a tensile test of a polyimide film, the plastic deformation region refers to a region of strain after the yield point. The property of “being less likely to plastically deform” means that in the plastic deformation region, the stress greatly increases or a large stress is required at the time of plastic deformation. The index of the property of “being less likely to plastically deform” is, for example, the inclination of the plastic deformation region. The inclination of the plastic deformation region is, for example, the inclination of the s-s curve in the plastic deformation region of a graph in which the vertical axis represents the “stress (unit: MPa)” and the horizontal axis represents the “strain (unit: mm)” to show the result of measuring the tensile property in accordance with ASTM D882. The inclination of the s-s curve in the plastic deformation region can be calculated with the following calculation formula. In the following formula, stress 1 represents the stress at 10% strain, stress 2 represents the breaking stress, strain 1 represents the 10% strain, and strain 2 represents the breaking strain.

$$Inclination of s - s curve in plastic deformation region = ( stress 2 - stress 1 ) / ( strain 2 - strain 1 )$$

The non-thermoplastic polyimide layer may have an inclination of the plastic deformation region of 2.0 or more, or 2.2 or more. In a case where the inclination of the plastic deformation region is 2.0 or more, an aggregate structure is formed that has a high degree of polymer chain packing, and a tear can be suppressed even in a continuous FPC processing step. The inclination of the plastic deformation region may be as high as possible, but in order to suppress spring back and the like, the inclination of the plastic deformation region may be 4.5 or less, or 4.0 or less.

The non-thermoplastic polyimide layer may have a linear thermal expansion coefficient of 5.0 ppm/K or more and 19.0 ppm/K or less, 6.0 ppm/K or more and 15.0 ppm/K or less, or 7.0 ppm/K or more and 12.0 ppm/K or less. If the non-thermoplastic polyimide layer has a linear thermal expansion coefficient of 5.0 ppm/K or more and 19.0 ppm/K or less, the linear thermal expansion coefficient of the multi-layered polyimide film can be adjusted to, for example, 14.0 ppm/K or more and 22.0 ppm/K or less, which is a value close to the linear thermal expansion coefficient of a copper foil, and desirably 16.0 ppm/K or more and 20.0 ppm/K or less, which is a value closer to the linear thermal expansion coefficient of a copper foil. Thus, at the time of bonding a copper foil and a multi-layered polyimide film to each other at a high temperature, a difference in thermal expansion can be reduced between the copper foil and the film. As a result, a dimensional change of the resulting copper-clad laminate (FCCL) can be suppressed. The linear thermal expansion coefficient can be adjusted, for example, by changing the content rate of a residue derived from a monomer having a rigid structure (more specifically, a BPDI residue or the like) and the content rate of a residue derived from a monomer having a bend structure (more specifically, a BENDA residue or the like).

### [Structure of Multi-Layered Polyimide Film]

Next, the structure of the multi-layered polyimide film according to the first embodiment will be described with reference to the drawings.

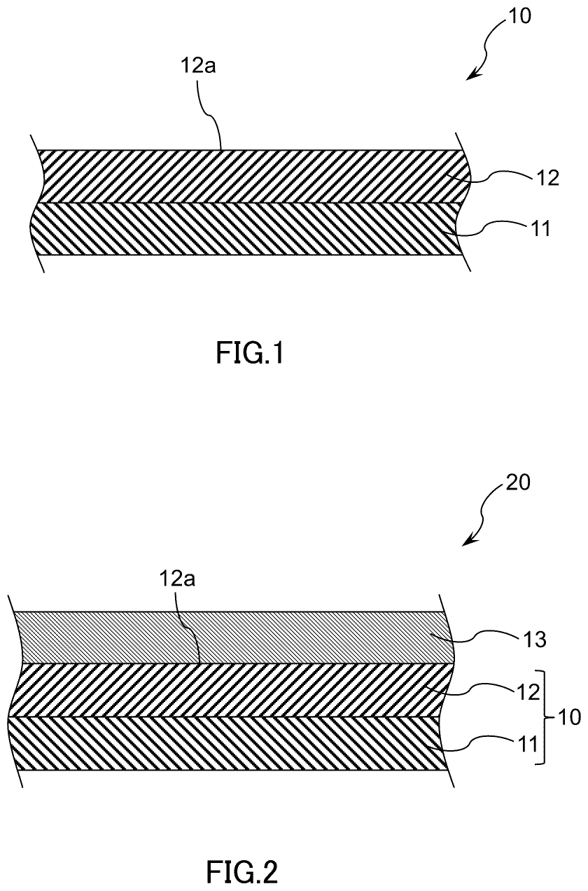

FIG. 1 is a sectional view showing an example of the multi-layered polyimide film according to the first embodiment. As shown in FIG. 1, a multi-layered polyimide film 10 includes a non-thermoplastic polyimide layer 11 and a thermoplastic polyimide layer 12 disposed on at least one surface of the non-thermoplastic polyimide layer 11. A non-thermoplastic polyimide contained in the non-thermoplastic polyimide layer 11 has a BENDA residue as a tetracarboxylic dianhydride residue, and has a BPDI residue as a diamine residue. The multi-layered polyimide film 10 has a content rate of the BPDI residue in the non-thermoplastic polyimide of 30 mol % or more and 100 mol % or less with respect to all of diamine residues included in the non-thermoplastic polyimide.

In the multi-layered polyimide film 10 shown in FIG. 1, the thermoplastic polyimide layer 12 is provided only on one surface of the non-thermoplastic polyimide layer 11, but the thermoplastic polyimide layer 12 may be provided on each of both surfaces (both main surfaces) of the non-thermoplastic polyimide layer 11. In a case where the thermoplastic polyimide layer 12 is provided on each of both surfaces of the non-thermoplastic polyimide layer 11, the two thermoplastic polyimide layers 12 may contain the same kind of thermoplastic polyimide or different kinds of thermoplastic polyimides from each other. The thicknesses of the two thermoplastic polyimide layers 12 may be the same or different. In one or more embodiments of the present invention, two or more of the non-thermoplastic polyimide layers 11 and two or more of the thermoplastic polyimide layers 12 may be provided. In the following description, examples of the “multi-layered polyimide film 10” include a film in which the thermoplastic polyimide layer 12 is provided only on one surface of the non-thermoplastic polyimide layer 11, a film in which the thermoplastic polyimide layer 12 is provided on each of both surfaces of the non-thermoplastic polyimide layer 11, and a film in which two or more of the non-thermoplastic polyimide layers 11 and two or more of the thermoplastic polyimide layers 12 are provided.

The thickness of the multi-layered polyimide film 10 (total thickness of the layers) is, for example, 6 μm or more and 60 μm or less. The thinner the thickness of the multi-layered polyimide film 10 is, the easier the weight reduction of the resulting FPC is, and the more improved the bendability of the resulting FPC is. For easier weight reduction of the FPC with securing the mechanical strength and for further improvement in bendability of the FPC, the thickness of the multi-layered polyimide film 10 may be 7 μm or more and 30 μm or less, or 10 μm or more and 25 μm or less. The thickness of the multi-layered polyimide film 10 can be measured by using a laser hologage.

For easy achievement of the thickness reduction of the FPC with securing the adhesion between a main surface 12a of the thermoplastic polyimide layer 12 and a metal foil, the thickness of the thermoplastic polyimide layer 12 (thickness of each thermoplastic polyimide layer 12 in a case where two or more of the thermoplastic polyimide layers 12 are provided) may be 1 μm or more and 15 μm or less. For easy adjustment of the linear thermal expansion coefficient of the multi-layered polyimide film 10, the thickness ratio between the non-thermoplastic polyimide layer 11 and the thermoplastic polyimide layer 12 (thickness of non-thermoplastic polyimide layer 11/thickness of thermoplastic polyimide layer 12) may be 55/45 or more and 95/5 or less. In a case where at least one of the non-thermoplastic polyimide layer 11 or the thermoplastic polyimide layer 12 is provided in a plurality of layers, the total thickness is used as the thickness in calculation of the thickness ratio. Even in a case where the number of thermoplastic polyimide layers 12 is large, the total thickness of the thermoplastic polyimide layers 12 may be not more than the total thickness of the non-thermoplastic polyimide layers 11.

In order to suppress warpage of the multi-layered polyimide film 10, the thermoplastic polyimide layer 12 may be provided on each of both surfaces of the non-thermoplastic polyimide layer 11, and the thermoplastic polyimide layers 12 containing the same kind of thermoplastic polyimide may be provided on both surfaces of the non-thermoplastic polyimide layer 11. In a case where the thermoplastic polyimide layer 12 is provided on each of both surfaces of the non-thermoplastic polyimide layer 11, the thicknesses of the two thermoplastic polyimide layers 12 may be the same for suppressing warpage of the multi-layered polyimide film 10. Even in a case where the thicknesses of the two thermoplastic polyimide layers 12 are different from each other, warpage of the multi-layered polyimide film 10 can be suppressed if the thickness of the thinner thermoplastic polyimide layer 12 is in the range of 40% or more and less than 100% based on the thickness of the thicker thermoplastic polyimide layer 12.

### [Elements of Multi-Layered Polyimide Film]

Next, elements (constituent elements) of the multi-layered polyimide film according to the first embodiment will be described in detail.

### (Non-Thermoplastic Polyimide Layer)

The non-thermoplastic polyimide contained in the non-thermoplastic polyimide layer has a BPDI residue as a diamine residue. Examples of the diamine (monomer) for formation of the BPDI residue include 4,4′-diamino-2,2′-dimethylbiphenyl (hereinafter, sometimes referred to as “m-TB”), 4,4′-diaminobiphenyl, 4,4′-diamino-3,3′-dimethylbiphenyl, 4,4′-diamino-2,2′-dimethoxybiphenyl, 4,4′-diamino-3,3′-dimethoxybiphenyl, 3,3′,5,5′-tetramethylbenzidine, and 4,4′-bis(4-aminophenoxy) biphenyl. In one or more embodiments, as the diamine for formation of the BPDI residue, one or two or more diamines can be used. In order to further suppress reduction in film strength caused by a desmear treatment, the diamine (monomer) for formation of the BPDI residue may be m-TB. That is, the BPDI residue may be an m-TB residue.

The non-thermoplastic polyimide may have a diamine residue other than the BPDI residue (another diamine residue), as a diamine residue. The diamine (monomer) for formation of another diamine residue may be an aromatic diamine having high heat resistance. Specific examples of the diamine for formation of another diamine residue include p-phenylenediamine (hereinafter, sometimes referred to as “PDA”), 4,4′-diaminodiphenyl ether (hereinafter, sometimes referred to as “ODA”), 2,2-bis[4-(4-aminophenoxy)phenyl]propane (hereinafter, sometimes referred to as “BAPP”), 1,3-bis(4-aminophenoxy)benzene, 1,4-bis(4-aminophenoxy)benzene, 4,4′-diaminodiphenylpropane, 4,4′-diaminodiphenylmethane, 4,4′-diaminodiphenyl sulfide, 3,3′-diaminodiphenyl sulfone, 4,4′-diaminodiphenyl sulfone, 3,3′-diaminodiphenyl ether, 3,4′-diaminodiphenyl ether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl N-methylamine, 4,4′-diaminodiphenyl N-phenylamine, 1,3-diaminobenzene, 1,2-diaminobenzene, and derivatives thereof.

Another diamine residue may be a combination of one or more diamine residues having a flexible structure selected from the group consisting of an ODA residue, a BAPP residue, a 1,3-diaminobenzene residue, and a 1,3-bis(4-aminophenoxy)benzene residue and a PDA residue having a rigid structure, or a combination of an ODA residue and a PDA residue.

The content rate of another diamine residue is 0 mol % or more and 70 mol % or less with respect to all of the diamine residues included in the non-thermoplastic polyimide. From the viewpoint of securing high heat resistance, the content rate of the diamine residue having a rigid structure in another diamine residue may be 10 mol % or more and 50 mol % or less, 15 mol % or more and 40 mol % or less, or 15 mol % or more and 35 mol % or less with respect to all of the diamine residues included in the non-thermoplastic polyimide. In order to adjust the linear thermal expansion coefficient of the multi-layered polyimide film to an appropriate range, the content rate of the diamine residue having a flexible structure in another diamine residue may be 20 mol % or more and 60 mol % or less, 25 mol % or more and 55 mol % or less, or 30 mol % or more and 50 mol % or less with respect to all of the diamine residues included in the non-thermoplastic polyimide.

The non-thermoplastic polyimide contained in the non-thermoplastic polyimide layer has a BENDA residue as an acid dianhydride residue. Examples of the acid dianhydride (monomer) for formation of the BENDA residue include 3,3′,4,4′-benzophenonetetracarboxylic dianhydride (hereinafter, sometimes referred to as “BTDA”), 2,2′,3,3′-benzophenonetetracarboxylic dianhydride, and 2,3,3′,4′-benzophenonetetracarboxylic dianhydride. In one or more embodiments, as the acid dianhydride for formation of the BENDA residue, one or two or more acid dianhydrides can be used. In order to further suppress reduction in film strength caused by a desmear treatment, the acid dianhydride (monomer) for formation of the BENDA residue may be BTDA. That is, the BENDA residue may be a BTDA residue.

The non-thermoplastic polyimide may have an acid dianhydride residue other than the BENDA residue (another acid dianhydride residue), as an acid dianhydride residue. Examples of the acid dianhydride (monomer) for formation of another acid dianhydride residue include pyromellitic dianhydride (hereinafter, sometimes referred to as “PMDA”), 3,3′,4,4′-biphenyltetracarboxylic dianhydride (hereinafter, sometimes referred to as “BPDA”), 2,3,6,7-naphthalenetetracarboxylic dianhydride, 1,2,5,6-naphthalenetetracarboxylic dianhydride, 2,2′,3,3′-biphenyltetracarboxylic dianhydride, 4,4′-oxydiphthalic anhydride (hereinafter, sometimes referred to as “ODPA”), 3,4′-oxydiphthalic anhydride, 2,2-bis(3,4-dicarboxyphenyl) propane dianhydride, 3,4,9,10-perylenetetracarboxylic dianhydride, 1,1-bis(2,3-dicarboxyphenyl) ethane dianhydride, 1,1-bis(3,4-dicarboxyphenyl) ethane dianhydride, p-phenylenebis(trimellitic acid monoester acid anhydride), ethylenebis(trimellitic acid monoester acid anhydride), bisphenol A bis(trimellitic acid monoester acid anhydride), and derivatives thereof.

From the viewpoint of securing high heat resistance and low thermal expansion, another acid dianhydride residue may be one or more selected from the group consisting of a PMDA residue, a BPDA residue, and an ODPA residue, one or more selected from the group consisting of a PMDA residue and a BPDA residue, or a PMDA residue. From the viewpoint of securing high heat resistance and low thermal expansion, the content rate of another acid dianhydride residue may be 70 mol % or less, 10 mol % or more and 70 mol % or less, 30 mol % or more and 70 mol % or less, or 50 mol % or more and 70 mol % or less with respect to all of the acid dianhydride residues included in the non-thermoplastic polyimide.

In order to suppress a crack and a tear in a film in a FPC production process while maintaining the good appearance of the surface of the metal-clad laminate, the non-thermoplastic polyimide may have a segment including a repeating unit that is a structural unit represented by the following chemical formula (3). In the present description, the term “segment” refers to a polymer chain included in a block copolymer and formed from the same repeating units. In the present description, the term “block copolymer” refers to all aspects of a pure block copolymer, a random block copolymer, and a copolymer having a tapered block structure.

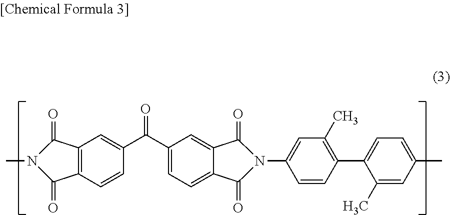

The segment including a repeating unit that is the structural unit represented by the chemical formula (3) (hereinafter, sometimes referred to as “specific segment”) can be formed, for example, by sequence polymerization described below.

The non-thermoplastic polyimide layer may contain a component (additive) other than the non-thermoplastic polyimide. As the additive, for example, a dye, a surfactant, a leveling agent, a plasticizer, silicone, a filler, a sensitizer, or the like can be used. The content rate of the non-thermoplastic polyimide in the non-thermoplastic polyimide layer is, for example, 70 wt % or more, 80 wt % or more, or 90 wt % or more, and may be 100 wt % with respect to the total amount of the non-thermoplastic polyimide layer.

### (Thermoplastic Polyimide Layer)

The thermoplastic polyimide contained in the thermoplastic polyimide layer has an acid dianhydride residue and a diamine residue. Examples of the acid dianhydride (monomer) for formation of the acid dianhydride residue in the thermoplastic polyimide include the same compound as the acid dianhydride (monomer) for formation of the acid dianhydride residue in the non-thermoplastic polyimide described above. The kind of the acid dianhydride residue of the thermoplastic polyimide and the kind of the acid dianhydride residue of the non-thermoplastic polyimide may be the same or different.

In order to secure the thermoplasticity, the diamine residue of the thermoplastic polyimide may be a diamine residue having a bend structure. In order to more easily secure the thermoplasticity, the content rate of the diamine residue having a bend structure may be 50 mol % or more, 70 mol % or more, or 80 mol % or more, and may be 100 mol % with respect to all of the diamine residues included in the thermoplastic polyimide. Examples of the diamine (monomer) for formation of the diamine residue having a bend structure include 4,4′-bis(4-aminophenoxy) biphenyl, 4,4′-bis(3-aminophenoxy) biphenyl, 1,3-bis(3-aminophenoxy)benzene, 1,3-bis(4-aminophenoxy)benzene, and BAPP. In order to more easily secure the thermoplasticity, the diamine residue of the thermoplastic polyimide may be a BAPP residue.

In order to obtain the thermoplastic polyimide layer excellent in adhesion to a metal foil, the thermoplastic polyimide may have one or more selected from the group consisting of a BPDA residue and a PMDA residue, and a BAPP residue. In order to further suppress reduction in film strength caused by a desmear treatment, the total content rate of the BPDA residue and the PMDA residue may be 85 mol % or more and 100 mol % or less, more than 85 mol % and 100 mol % or less, 90 mol % or more and 100 mol % or less, 95 mol % or more and 100 mol % or less, or 100 mol % with respect to all of the acid dianhydride residues included in the thermoplastic polyimide.

The thermoplastic polyimide layer may contain a component (additive) other than the thermoplastic polyimide. As the additive, for example, a dye, a surfactant, a leveling agent, a plasticizer, silicone, a filler, a sensitizer, or the like can be used. The content rate of the thermoplastic polyimide in the thermoplastic polyimide layer is, for example, 70 wt % or more, 80 wt % or more, or 90 wt % or more, and may be 100 wt % with respect to the total amount of the thermoplastic polyimide layer.

### Preferred Aspect of First Embodiment

In order to secure high heat resistance and low thermal expansion while further suppressing reduction in film strength caused by a desmear treatment, the multi-layered polyimide film according to the first embodiment may satisfy the following condition 1, the following condition 2, or the following condition 3. In order to obtain a multi-layered polyimide film capable of effectively suppressing reduction in film strength caused by a desmear treatment and capable of securing high heat resistance while the linear thermal expansion coefficient of the film is adjusted to an appropriate range, the multi-layered polyimide film according to the first embodiment may satisfy the following condition 4.
Condition 1: The content rate of the BPDI residue in the non-thermoplastic polyimide is mol % or more and 70 mol % or less with respect to all of the diamine residues included in the non-thermoplastic polyimide, and the content rate of the BENDA residue in the non-thermoplastic polyimide is 30 mol % or more and 70 mol % or less with respect to all of the tetracarboxylic dianhydride residues included in the non-thermoplastic polyimide.
Condition 2: The condition 1 is satisfied, and the non-thermoplastic polyimide further has a PDA residue as a diamine residue.
Condition 3: The condition 2 is satisfied, and the non-thermoplastic polyimide further has a PMDA residue as an acid dianhydride residue.
Condition 4: The condition 3 is satisfied, and the non-thermoplastic polyimide further has an ODA residue as a diamine residue.

### Second Embodiment: Metal-Clad Laminate

Next, a metal-clad laminate according to a second embodiment of the present invention will be described. The metal-clad laminate according to the second embodiment of the present invention is a metal-clad laminate obtained by using the above-described multi-layered polyimide film according to the first embodiment of the present invention. In the following description, description of contents overlapping with the contents of the first embodiment may be omitted.

The metal-clad laminate according to the second embodiment includes the multi-layered polyimide film according to the first embodiment and a metal layer disposed on a main surface of at least one of the thermoplastic polyimide layer of the multi-layered polyimide film. According to the second embodiment, the multi-layered polyimide film according to the first embodiment is included, and therefore a defect (such as a crack or a tear) can be suppressed in the substrate (multi-layered polyimide film) in a FPC production process. Hereinafter, an example of the metal-clad laminate according to the second embodiment will be described with reference to FIG. 2. FIG. 2 is a sectional view showing an example of the metal-clad laminate according to the second embodiment.

As shown in FIG. 2, a metal-clad laminate 20 includes the multi-layered polyimide film and a metal layer 13 disposed on the main surface 12a of at least one of the thermoplastic polyimide layer 12 of the multi-layered polyimide film 10.

As the metal layer 13, a metal foil can be used. The metal foil is not particularly limited, and any metal foil can be used. For example, a metal foil is suitably used that includes any of copper, stainless steel, nickel, aluminum, alloys of these metals, and the like as a material. In general metal-clad laminates, a copper foil such as a rolled copper foil or an electrolytic copper foil is often used, and also in the second embodiment, a copper foil may be used.

As the metal foil, a metal foil can be used that is subjected to a surface treatment or the like to adjust the surface roughness or the like according to the purpose. Furthermore, a rustproof layer, a heat resistant layer, an adhesive layer, and the like may be formed on the surface of the metal foil. The thickness of the metal layer 13 is not particularly limited, and may be any thickness as long as a sufficient function can be exhibited according to the use. For easy achievement of the thickness reduction of the FPC while suppressing generation of creases in bonding to the multi-layered polyimide film 10, the thickness of the metal layer 13 may be 5 μm or more and 50 μm or less.

In production of the metal-clad laminate 20 by using the multi-layered polyimide film 10, a metal foil as the metal layer 13 is bonded to at least one surface of the multi-layered polyimide film (for example, in FIG. 2, the main surface 12a of the thermoplastic polyimide layer 12). The method of bonding a metal foil to the main surface 12a of the thermoplastic polyimide layer 12 is not particularly limited, and various known methods can be adopted. For example, a continuous processing method can be adopted in which a hot-roll lamination apparatus having one or more pairs of metal rolls, or a double belt press (DBP) is used. The specific configuration for the way of hot-roll lamination is not particularly limited, and for improving the appearance of the obtained metal-clad laminate 20, a protective material may be disposed between the pressed surface and the metal foil.

In a case where the thermoplastic polyimide layer 12 is provided on each of both surfaces of the non-thermoplastic polyimide layer 11, the metal foil is bonded to each of both surfaces of the multi-layered polyimide film 10 to obtain a double-sided metal-clad laminate (not shown).

In the case of producing a FPC using the metal-clad laminate 20, the yield rate of the FPC can be enhanced even if the roll-to-roll type process is adopted. That is, even when a desmear treatment is performed in the roll-to-roll type process, reduction in the strength of the multi-layered polyimide film 10 in the metal-clad laminate 20 is suppressed, so that a defect can be suppressed in the substrate (multi-layered polyimide film 10) in the FPC production process. As the desmear treatment method, a known method can be adopted, and examples of the method include a wet desmear treatment method including a swelling step using an alkaline aqueous solution or a solution containing an organic solvent, a roughening step using an alkaline aqueous solution containing sodium permanganate, potassium permanganate, or the like, and a neutralization step.

### <Method of Producing Multi-Layered Polyimide Film>

Next, an example of a method of producing the multi-layered polyimide film according to the first embodiment will be described.

### [Method of Producing Polyamic Acid]

As the method of producing (synthesizing) the polyamic acid as a precursor of the polyimide, any of known methods and combinations thereof can be used. The polymerization method in production of the polyamic acid is characterized by the order of addition of the monomers, and various physical properties of the resulting polyimide can be controlled by controlling the order of addition of the monomers. In the case of synthesizing the polyamic acid using a diamine and a tetracarboxylic dianhydride, the desired polyamic acid (polymer of the diamine and the tetracarboxylic dianhydride) can be obtained by adjusting the substance amount of the diamine (substance amount of each diamine in the case of using a plurality of diamines) and the substance amount of the tetracarboxylic dianhydride (substance amount of each tetracarboxylic dianhydride in the case of using a plurality of tetracarboxylic dianhydrides). The molar fraction of each residue in the polyimide formed from the polyamic acid is equal to, for example, the molar fraction of each monomer (each of the diamines and the tetracarboxylic dianhydrides) used for synthesis of the polyamic acid. The temperature condition for the reaction of the diamine and the tetracarboxylic dianhydride, that is, the synthesis reaction of the polyamic acid is not particularly limited, and is, for example, in the range of 10° C. or higher and 150° C. or lower. The time for the synthesis reaction of the polyamic acid is, for example, in the range of 10 minutes or more and 30 hours or less. In production of the polyamic acid, any method of adding a monomer may be used. Examples of the typical method of producing the polyamic acid include the following methods.

Examples of the method of producing the polyamic acid include a method in which polymerization is performed by the following steps (A-a) and (A-b) (hereinafter, sometimes referred to as “polymerization method A”).
(A-a): The step of reacting an aromatic diamine with an aromatic acid dianhydride in an organic solvent with the aromatic diamine being in excess to obtain a prepolymer having an amino group at both ends.
(A-b): The step of adding an aromatic diamine different in structure from that used in the step (A-a), and further adding an aromatic acid dianhydride different in structure from that used in the step (A-a) so that the amount of the aromatic diamines and the amount of the aromatic acid dianhydrides in the entire steps are substantially equal to each other in terms of mol, and thus performing polymerization.

Examples of the method of producing the polyamic acid also include a method in which polymerization is performed by the following steps (B-a) and (B-b) (hereinafter, sometimes referred to as “polymerization method B”).
(B-a): The step of reacting an aromatic diamine with an aromatic acid dianhydride in an organic solvent with the aromatic acid dianhydride being in excess to obtain a prepolymer having an acid anhydride group at both ends.
(B-b): The step of adding an aromatic acid dianhydride different in structure from that used in the step (B-a), and further adding an aromatic diamine different in structure from that used in the step (B-a) so that the amount of the aromatic diamines and the amount of the aromatic acid dianhydrides in the entire steps are substantially equal to each other in terms of mol, and thus performing polymerization.

A polymerization method in which the order of addition is set so that a specific diamine or a specific acid dianhydride selectively reacts with any or a specific diamine or any or a specific acid dianhydride (for example, the polymerization method A or polymerization method B described above) is referred to as sequence polymerization in the present description. Among polymers obtained by sequence polymerization, a polymer having two kinds of segments is referred to as a diblock copolymer, and a polymer having three kinds of segments is referred to as a triblock copolymer. In contrast, a polymerization method in which the order of addition of a diamine and an acid dianhydride is not set (polymerization method in which monomers freely react with each other) is referred to as random polymerization in the present description. A polymer obtained by random polymerization is referred to as a random copolymer.

The polymerization method of obtaining a polyimide capable of further suppressing reduction in film strength caused by a desmear treatment may be sequence polymerization.

The polyamic acid obtained by the above-described polymerization method may have a weight average molecular weight in the range of 10,000 or more and 1,000,000 or less, in the range of 20,000 or more and 500,000 or less, or in the range of 30,000 or more and 200,000 or less. If the weight average molecular weight is 10,000 or more, a coating film is easily obtained by using the polyamic acid. Meanwhile, if the weight average molecular weight is 1,000,000 or less, sufficient solubility is exhibited in a solvent, and therefore a coating film having a smooth surface and a uniform thickness is obtained using a polyamic acid solution described below. The weight average molecular weight used herein refers to a value in terms of polyethylene oxide measured using gel permeation chromatography (GPC).

For obtaining the polyimide, a method may be adopted in which the polyimide is obtained from a polyamic acid solution containing the polyamic acid and an organic solvent. Examples of the organic solvent usable in the polyamic acid solution include urea-based solvents such as tetramethylurea and N,N-dimethylethylurea; sulfoxide-based solvents such as dimethyl sulfoxide; sulfone-based solvents such as diphenyl sulfone and tetramethyl sulfone; amide-based solvents such as N,N-dimethylacetamide, N,N-dimethylformamide (hereinafter, sometimes referred to as “DMF”), N,N-diethylacetamide, N-methyl-2-pyrrolidone, and hexamethylphosphoric triamide; ester-based solvents such as γ-butyrolactone; alkyl halide-based solvents such as chloroform and methylene chloride; aromatic hydrocarbon-based solvents such as benzene and toluene; phenol-based solvents such as phenol and cresol; ketone-based solvents such as cyclopentanone; and ether-based solvents such as tetrahydrofuran, 1,3-dioxolane, 1,4-dioxane, dimethyl ether, diethyl ether, diethylene glycol diethyl ether, diethylene glycol dimethyl ether, and p-cresol methyl ether. These solvents are normally used singly, and if necessary, may be appropriately used in combination of two or more kinds thereof. In the case of obtaining the polyamic acid by the above-described polymerization method, the reaction solution (solution after reaction) itself may be a polyamic acid solution used for obtaining the polyimide. In this case, the organic solvent in the polyamic acid solution is the organic solvent used in the reaction in the polymerization method. Alternatively, the solid polyamic acid obtained by removing the solvent from the reaction solution may be dissolved in an organic solvent to prepare a polyamic acid solution.

To the polyamic acid solution, an additive may be added such as a dye, a surfactant, a leveling agent, a plasticizer, silicone, or a sensitizer. In addition, a filler can be added to the polyamic acid solution for the purpose of improving various properties of the film such as the slidability, the heat conductivity, the electrical conductivity, the corona resistance, and the loop stiffness. Any filler may be used, and preferred examples of the filler include fillers composed of silica, titanium oxide, alumina, silicon nitride, boron nitride, calcium hydrogen phosphate, calcium phosphate, mica, or the like.

The concentration of the polyamic acid in the polyamic acid solution is not particularly limited, and is, for example, 5 wt % or more and 35 wt % or less, or 8 wt % or more and 30 wt % or less with respect to the total amount of the polyamic acid solution. If the concentration of the polyamic acid is 5 wt % or more and 35 wt % or less, an appropriate molecular weight and an appropriate solution viscosity are obtained.

### [Method of Forming Non-Thermoplastic Polyimide Layer]

The method of forming the non-thermoplastic polyimide layer is not particularly limited, and various known methods can be applied. Examples thereof include a method in which the non-thermoplastic polyimide layer (polyimide film) is formed through the following steps i) to iv).
Step i): The step of reacting an aromatic diamine with an aromatic tetracarboxylic dianhydride in an organic solvent to obtain a polyamic acid solution containing a precursor of the non-thermoplastic polyimide (hereinafter, sometimes referred to as “non-thermoplastic polyamic acid solution”).
Step ii): The step of applying a dope solution containing the non-thermoplastic polyamic acid solution onto a support to form a coating film.
Step iii): The step of heating the coating film on the support to obtain a polyamic acid film (hereinafter, sometimes referred to as “gel film”) having a self-supporting property, and then peeling off the gel film from the support.
Step iv): The step of heating the gel film to imidize the polyamic acid in the gel film and drying the gel film to obtain a polyimide film containing the non-thermoplastic polyimide (polyimide film to be the non-thermoplastic polyimide layer in the multi-layered polyimide film).

The method of applying a dope solution onto a support in the step ii) is not particularly limited, and a method using a conventionally known applicator such as a die coater, a Comma Coater (registered trademark), a reverse coater, or a knife coater can be adopted.

Methods in the step ii) and the subsequent steps are roughly classified into a thermal imidization method and a chemical imidization method. The thermal imidization method is a method in which is the polyamic acid solution is applied as a dope solution onto a support without using a dehydrating and ring-closing agent or the like, and heated to promote imidization. The chemical imidization method is a method in which a solution obtained by adding at least one of a dehydrating and ring-closing agent or a catalyst as an imidization accelerator to the polyamic acid solution is used as a dope solution to accelerate imidization. Either of the methods may be used, and the chemical imidization method is superior in productivity.

As the dehydrating and ring-closing agent, an acid anhydride typified by acetic anhydride is suitably used. The catalyst may be a tertiary amine such as an aliphatic tertiary amine, an aromatic tertiary amine, or a heterocyclic tertiary amine, or isoquinoline.

As the support to which the dope solution is applied in the step ii), a glass plate, an aluminum foil, an endless stainless belt, a stainless drum, or the like is suitably used. In the step iii), the heating conditions are set according to the ultimately obtained film thickness and the production speed, and the film is partially subjected to at least one of imidization or drying and then peeled off from the support to obtain a polyamic acid film (gel film).

Subsequently, in the step iv), for example, while the ends of the gel film are fixed to avoid shrinkage during curing, a heating treatment is performed to remove water, the remaining solvent, the imidization accelerator, and the like from the gel film, and the remaining polyamic acid is completely imidized to obtain a polyimide film containing the non-thermoplastic polyimide. The heating conditions are to be appropriately set according to the ultimately obtained film thickness and the production speed.

### [Method of Forming Thermoplastic Polyimide Layer]

The thermoplastic polyimide layer is formed by, for example, applying a polyamic acid solution containing a polyamic acid as a precursor of the thermoplastic polyimide (hereinafter, sometimes referred to as “thermoplastic polyamic acid solution”) to at least one surface of the polyimide film (non-thermoplastic polyimide layer) obtained using the above-described non-thermoplastic polyamic acid solution, and then performing heating (drying and imidization of the polyamic acid). This method provides a multi-layered polyimide film including the non-thermoplastic polyimide layer and the thermoplastic polyimide layer disposed on at least one surface of the non-thermoplastic polyimide layer. Instead of the thermoplastic polyamic acid solution, a solution containing the thermoplastic polyimide (thermoplastic polyimide solution) may be used to form a coating film of the thermoplastic polyimide solution on at least one surface of the non-thermoplastic polyimide layer, and the coating film may be dried to form the thermoplastic polyimide layer.

Alternatively, for example, a laminate including a layer containing a polyamic acid as a precursor of the non-thermoplastic polyimide and a layer containing a polyamic acid as a precursor of the thermoplastic polyimide may be formed on a support by using a coextrusion die, and then the obtained laminate may be heated to form the non-thermoplastic polyimide layer and the thermoplastic polyimide layer at the same time. Alternatively, a laminate including a layer containing a polyamic acid as a precursor of the non-thermoplastic polyimide and a layer containing a polyamic acid as a precursor of the thermoplastic polyimide may be formed by continuous application (continuous casting), and then the obtained laminate may be heated to form the non-thermoplastic polyimide layer and the thermoplastic polyimide layer at the same time. In these methods, a metal foil is used as the support, and thus a metal-clad laminate (laminate of the multi-layered polyimide film and the metal foil) is obtained simultaneously with completion of the imidization. In the case of producing a multi-layered polyimide film including three or more polyimide layers, a method is suitably used in which the application step and the heating step described above are repeated a plurality of times, or a plurality of coating films are formed by co-extrusion or continuous application (continuous casting) and heated at a time. Various surface treatments such as a corona treatment and a plasma treatment can also be performed on the outermost surface of the multi-layered polyimide film.

### EXAMPLES

Hereinafter, one or more embodiments of the present invention will be specifically described with reference to examples, but one or more embodiments of the present invention are not limited to these examples.

### <Methods of Measuring Physical Properties>

First, methods of measuring physical properties of a polyimide film will be described.

### [Tensile Modulus, Stress at 10% Strain, and Inclination of Plastic Deformation Region]

The tensile modulus of the polyimide film was measured in accordance with ASTM D882 using a precision universal testing machine (“AUTOGRAPH AGS-J” manufactured by Shimadzu Corporation). The stress at 10% strain was determined by reading the tensile stress at 10% strain from the measurement data of the tensile modulus. The inclination of the plastic deformation region was calculated from the measurement data of the tensile modulus in accordance with the above-described calculation formula. The measurement conditions of the tensile modulus are shown below.
Width of sample (polyimide film): 15 mm
Distance between grippers: 100 mm
Tension rate: 200 mm/min
Measurement environment: temperature of 23° C. and humidity of 55% RH

### [Linear Thermal Expansion Coefficient (CTE)]

Using a thermal analyzer (“TMA/SS6100” manufactured by Hitachi High-Tech Science Corporation), the polyimide film was heated from −10° C. to 300° C. in a nitrogen atmosphere under a condition of a temperature rise rate of 10° C./min, then cooled to −10° C. at a temperature fall rate of 40° C./min, and further heated again to 300° C. under a condition of a temperature rise rate of 10° C./min, and the linear thermal expansion coefficient was determined from the strain amount from 50° C. to 250° C. at the second temperature rise. The measurement conditions are shown below.
Size of sample (polyimide film): Width of 3 mm and length of 10 mm
Load: 1 g (9.8 mN)

### [Desmear Liquid Resistance]

### (Desmear Treatment Conditions)

Table 1 shows desmear treatment conditions for evaluation of the desmear liquid resistance of the polyimide film. In Table 1, the numerical value in the column of “Concentration” is the concentration in the treatment liquid (aqueous solution). In addition, a water washing step was performed between the swelling step and the roughening step and between the roughening step and the neutralization step. Furthermore, a water washing step and a drying step were performed after the neutralization step. All of the chemical liquids used in the swelling step and the roughening step were manufactured by MacDermid Performance Solutions Japan K.K. The chemical liquid used in the neutralization step was manufactured by Rohm and Haas Electronic Materials.

TABLE 1

| | Chemical liquid | | | |
|---|---|---|---|---|
| | | Concen- | Treatment | Treatment |
| | | tration | temperature | time |
| | Product name | [wt %] | [° C.] | [min] |
| Swelling | Macudizer 9221-S | 40.4 | 50 | 5 |
| step | Macudizer 9276 | 3.0 | | |
| Roughening | Macudizer 9276 | 9.1 | 70 | 5 |
| step | Macudizer 9275 | 6.0 | | |
| Neutralization | CIRCUPOSIT MLB | 20.0 | 25 | 1 |
| step | Neutralizer 216-2 | | | |

### (Measurement of Breaking Strain)

For the polyimide film before the desmear treatment and the polyimide film after the desmear treatment under the above-described conditions, the breaking strain (strain at the time of breaking) was measured under the following conditions in accordance with ASTM D882 using a precision universal testing machine (“AUTOGRAPH AGS-J” manufactured by Shimadzu Corporation).
Shape of measurement sample: No. 6 dumbbell shape
Width of measurement sample at measurement point: 4 mm
Distance between grippers: 25 mm
Tension rate: 25 mm/min
Measurement environment: temperature of 23° C. and humidity of 55% RH

Subsequently, the strain retention rate (unit: %) was calculated in accordance with the formula “strain retention rate=100×breaking strain of polyimide film after desmear treatment/breaking strain of polyimide film before desmear treatment”. Then, a case where the strain retention rate was 80% or more was determined as “A”, a case where the strain retention rate was 50% or more and less than 80% was determined as “B”, and a case where the strain retention rate was less than 50% was determined as “C”. A case where the determination result was A was evaluated that “reduction in film strength caused by a desmear treatment can be suppressed”. A case where the determination result was B or C was evaluated that “reduction in film strength caused by a desmear treatment cannot be suppressed”.

### [Peel Strength]

A 12 μm-thick electrolytic copper foil (“3EC-M3S-HTE” manufactured by MITSUI MINING & SMELTING CO., LTD.) was disposed on each of both surfaces of the multi-layered polyimide film, and a protective film (“APICAL 125NPI” manufactured by KANEKA CORPORATION, thickness: 125 μm) was disposed on the outer surface of each electrolytic copper foil. In this state, lamination was performed under the conditions of a lamination temperature of 360° C., a lamination pressure of 307.7 N/cm, and a lamination speed of 1.0 m/min to obtain a flexible copper-clad laminate (FCCL).

Then, in accordance with JIS C 6471-1995, the peel strength was determined to be the average peel strength obtained by peeling the electrolytic copper foil (width: 1 mm) on one surface of the FCCL by 30 mm using a tensile tester (“Strograph VES 1D” manufactured by Toyo Seiki Seisaku-sho, Ltd.) in an environment of a temperature of 23° C. and a humidity of 55% RH under the conditions of a tension rate of 50 mm/min and a peel angle of 90°. In all of Examples 1 to 6 and Comparative Examples 1 to 5 described below, the peel strength was 12 N/cm or more.

### <Preparation of Polyamic Acid Solution>

Hereinafter, methods of preparing solutions P1 to P11 as a non-thermoplastic polyamic acid solution and a solution P12 as a thermoplastic polyamic acid solution will be described. All of the solutions P1 to P12 were prepared in a nitrogen atmosphere at a temperature of 20° C. In the following, compounds and reagents are represented by the following abbreviations.
DMF: N,N-dimethylformamide
PDA: p-phenylenediamine
ODA: 4,4′-diaminodiphenyl ether
m-TB: 4,4′-diamino-2,2′-dimethylbiphenyl
BAPP: 2,2-bis[4-(4-aminophenoxy)phenyl]propane
PMDA: pyromellitic dianhydride
BPDA: 3,3′,4,4′-biphenyltetracarboxylic dianhydride
BTDA: 3,3′,4,4′-benzophenonetetracarboxylic dianhydride
AA: acetic anhydride
IQ: isoquinoline

### [Preparation of Solution P1]

Into a glass flask having a volume of 2 L, 328.91 g of DMF, 11.85 g of ODA, and 11.17 g of m-TB were put, and then 19.07 g of BTDA was gradually added in the flask while the flask contents were stirred. After visually confirming dissolution of the BTDA, 9.04 g of PMDA was gradually added in the flask while the flask contents were stirred. After visually confirming dissolution of the PMDA, the flask contents were further stirred for 30 minutes. Subsequently, while the flask contents were stirred, 2.13 g of PDA was added in the flask, then 5.88 g of PMDA was added, and the flask contents were further stirred for 30 minutes. Subsequently, while the flask contents were stirred, a PMDA solution prepared in advance (solvent: DMF, amount of dissolved PMDA: 0.86 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P1, which was a non-thermoplastic polyamic acid solution, was obtained.

### [Preparation of Solution P2]

Into a glass flask having a volume of 2 L, 328.94 g of DMF, 9.19 g of ODA, and 13.92 g of m-TB were put, and then 19.02 g of BTDA was gradually added in the flask while the flask contents were stirred. After visually confirming dissolution of the BTDA, 9.01 g of PMDA was gradually added in the flask while the flask contents were stirred. After visually confirming dissolution of the PMDA, the flask contents were further stirred for 30 minutes. Subsequently, while the flask contents were stirred, 2.13 g of PDA was added in the flask, then 5.87 g of PMDA was added, and the flask contents were further stirred for 30 minutes. Subsequently, while the flask contents were stirred, a PMDA solution prepared in advance (solvent: DMF, amount of dissolved PMDA: 0.86 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P2, which was a non-thermoplastic polyamic acid solution, was obtained.

### [Preparation of Solution P3]

Into a glass flask having a volume of 2 L, 328.81 g of DMF, 9.30 g of ODA, and 12.68 g of m-TB were put, and then 19.24 g of BTDA was gradually added in the flask while the flask contents were stirred. After visually confirming dissolution of the BTDA, 9.26 g of PMDA was gradually added in the flask while the flask contents were stirred. After visually confirming dissolution of the PMDA, the flask contents were further stirred for 30 minutes. Subsequently, while the flask contents were stirred, 2.87 g of PDA was added in the flask, then 5.79 g of PMDA was added, and the flask contents were further stirred for 30 minutes. Subsequently, while the flask contents were stirred, a PMDA solution prepared in advance (solvent: DMF, amount of dissolved PMDA: 0.87 g PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P3, which was a non-thermoplastic polyamic acid solution, was obtained.

### [Preparation of Solution P4]

Into a glass flask having a volume of 2 L, 328.55 g of DMF, 9.52 g of ODA, and 11.53 g of m-TB were put, and then 17.50 g of BTDA was gradually added in the flask while the flask contents were stirred. After visually confirming dissolution of the BTDA, 9.48 g of PMDA was gradually added in the flask while the flask contents were stirred. After visually confirming dissolution of the PMDA, the flask contents were further stirred for 30 minutes. Subsequently, while the flask contents were stirred, 3.67 g of PDA was added in the flask, then 7.41 g of PMDA was added, and the flask contents were further stirred for 30 minutes. Subsequently, while the flask contents were stirred, a PMDA solution prepared in advance (solvent: DMF, amount of dissolved PMDA: 0.89 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P4, which was a non-thermoplastic polyamic acid solution, was obtained.

### [Preparation of Solution P5]

Into a glass flask having a volume of 2 L, 326.01 g of DMF and 23.83 g of m-TB were put, and then 35.09 g of BTDA was gradually added in the flask while the flask contents were stirred. After visually confirming dissolution of the BTDA, the flask contents were further stirred for 30 minutes. Subsequently, while the flask contents were stirred, a BTDA solution prepared in advance (solvent: DMF, amount of dissolved BTDA: 1.09 g, BTDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the BTDA solution and the stirring of the flask contents were stopped, and thus the solution P5, which was a non-thermoplastic polyamic acid solution, was obtained.

### [Preparation of Solution P6]

Into a glass flask having a volume of 2 L, 327.98 g of DMF, 9.99 g of ODA, and 9.08 g of m-TB were put, and then 13.78 g of BTDA was gradually added in the flask while the flask contents were stirred. After visually confirming dissolution of the BTDA, 8.86 g of PMDA was gradually added in the flask while the flask contents were stirred. After visually confirming dissolution of the PMDA, the flask contents were further stirred for 30 minutes. Subsequently, while the flask contents were stirred, 5.39 g of PDA was added in the flask, then 11.97 g of PMDA was added, and the flask contents were further stirred for 30 minutes. Subsequently, while the flask contents were stirred, a PMDA solution prepared in advance (solvent: DMF, amount of dissolved PMDA: 0.93 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P6, which was a non-thermoplastic polyamic acid solution, was obtained.

### [Preparation of Solution P7]

Into a glass flask having a volume of 2 L, 328.14 g of DMF, 8.45 g of ODA, and 7.46 g of m-TB were put, and then 20.39 g of BTDA was gradually added in the flask while the flask contents were stirred. After visually confirming dissolution of the BTDA, 1.38 g of PMDA was gradually added in the flask while the flask contents were stirred. After visually confirming dissolution of the PMDA, the flask contents were further stirred for 30 minutes. Subsequently, while the flask contents were stirred, 6.84 g of PDA was added in the flask, then 14.57 g of PMDA was added, and the flask contents were further stirred for 30 minutes. Subsequently, while the flask contents were stirred, a PMDA solution prepared in advance (solvent: DMF, amount of dissolved PMDA: 0.92 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P7, which was a non-thermoplastic polyamic acid solution, was obtained.

### [Preparation of Solution P8]

Into a glass flask having a volume of 2 L, 328.91 g of DMF, 5.27 g of ODA, and 16.20 g of BAPP were put, and then 8.48 g of BTDA was gradually added in the flask while the flask contents were stirred. After visually confirming dissolution of the BTDA, 7.17 g of PMDA was gradually added in the flask while the flask contents were stirred. After visually confirming dissolution of the PMDA, the flask contents were further stirred for 30 minutes. Subsequently, while the flask contents were stirred, 7.11 g of PDA was added in the flask, then 14.92 g of PMDA was added, and the flask contents were further stirred for 30 minutes. Subsequently, while the flask contents were stirred, a PMDA solution prepared in advance (solvent: DMF, amount of dissolved PMDA: 0.86 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P8, which was a non-thermoplastic polyamic acid solution, was obtained.

### [Preparation of Solution P9]

Into a glass flask having a volume of 2 L, 328.53 g of DMF and 17.70 g of ODA were put, and then 18.01 g of BPDA was gradually added in the flask while the flask contents were stirred. After visually confirming dissolution of the BPDA, 4.00 g of PMDA was gradually added in the flask while the flask contents were stirred. After visually confirming dissolution of the PMDA, the flask contents were further stirred for 30 minutes. Subsequently, while the flask contents were stirred, 5.77 g of m-TB was added in the flask, then 2.21 g of PDA was added, 11.42 g of PMDA was subsequently added, and the flask contents were further stirred for 30 minutes. Subsequently, while the flask contents were stirred, a PMDA solution prepared in advance (solvent: DMF, amount of dissolved PMDA: 0.89 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P9, which was a non-thermoplastic polyamic acid solution, was obtained.

### [Preparation of Solution P10]

Into a glass flask having a volume of 2 L, 328.64 g of DMF and 17.53 g of ODA were put, and then 11.89 g of BPDA was gradually added in the flask while the flask contents were stirred. After visually confirming dissolution of the BPDA, 6.51 g of BTDA was gradually added in the flask while the flask contents were stirred. After visually confirming dissolution of the BTDA, 11.31 g of PMDA was gradually added in the flask while the flask contents were stirred. After visually confirming dissolution of the PMDA, the flask contents were further stirred for 30 minutes. Subsequently, while the flask contents were stirred, 5.72 g of m-TB was added in the flask, then 2.19 g of PDA was added, 11.31 g of PMDA was subsequently added, and the flask contents were further stirred for 30 minutes. Subsequently, while the flask contents were stirred, a PMDA solution prepared in advance (solvent: DMF, amount of dissolved PMDA: 0.88 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P10, which was a non-thermoplastic polyamic acid solution, was obtained.

### [Preparation of Solution P11]

Into a glass flask having a volume of 2 L, 328.85 g of DMF and 17.21 g of ODA were put, and then 19.17 g of BTDA was gradually added in the flask while the flask contents were stirred. After visually confirming dissolution of the BTDA, 3.89 g of PMDA was gradually added in the flask while the flask contents were stirred. After visually confirming dissolution of the PMDA, the flask contents were further stirred for 30 minutes. Subsequently, while the flask contents were stirred, 5.61 g of m-TB was added in the flask, then 2.14 g of PDA was added, 11.10 g of PMDA was subsequently added, and the flask contents were further stirred for 30 minutes. Subsequently, while the flask contents were stirred, a PMDA solution prepared in advance (solvent: DMF, amount of dissolved PMDA: 0.87 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 2000 poises, the addition of the PMDA solution and the stirring of the flask contents were stopped, and thus the solution P11, which was a non-thermoplastic polyamic acid solution, was obtained.

### [Preparation of Solution P12]

Into a glass flask having a volume of 2 L, 673.24 g of DMF and 71.83 g of BAPP were put, and then 7.72 g of BPDA was gradually added in the flask while the flask contents were stirred. After visually confirming dissolution of the BPDA, 31.30 g of PMDA was gradually added in the flask while the flask contents were stirred. After visually confirming dissolution of the PMDA, the flask contents were further stirred for 30 minutes. Subsequently, while the flask contents were stirred, a PMDA solution prepared in advance (solvent: DMF, amount of dissolved PMDA: 1.15 g, PMDA concentration: 7.2 wt %) was continuously added in the flask for a predetermined time at an addition rate such that the viscosity of the flask contents did not rapidly increase. At the time when the viscosity of the flask contents at a temperature of 23° C. reached 300 poises, the addition of the PMDA solution and the stirring of the flask contents were stopped, and thus the solution P12, which was a thermoplastic polyamic acid solution, was obtained.

Table 2 shows the used diamines, the ratio of each diamine put into the flask, the used acid dianhydrides, and the ratio of each acid dianhydride put into the flask in each of the solutions P1 to P12. In Table 2, “-” means that the relevant component was not used. In Table 2, the numerical value in the column of “Diamine” is the content rate (unit: mol %) of each diamine with respect to the total amount (100 mol %) of the used diamines. In Table 2, the numerical value in the column of “Acid dianhydride” is the content rate (unit: mol %) of each acid dianhydride with respect to the total amount (100 mol %) of the used acid dianhydrides. In each of the solutions P1 to P12, the molar fraction of each residue of the polyamic acid in the prepared polyamic acid solution was equal to the molar fraction of each monomer (each of the diamines and the tetracarboxylic dianhydrides) used for synthesis of the polyamic acid.

TABLE 2

| | Diamine [mol %] | | | | Acid dianhydride [mol %] | | |
|---|---|---|---|---|---|---|---|
| Solution | PDA | ODA | m-TB | BAPP | PMDA | BPDA | BTDA |
| P1 | 15 | 45 | 40 | — | 55 | — | 45 |
| P2 | 15 | 35 | 50 | — | 55 | — | 45 |
| P3 | 20 | 35 | 45 | — | 55 | — | 45 |
| P4 | 25 | 35 | 40 | — | 60 | — | 40 |
| P5 | — | — | 100 | — | — | — | 100 |
| P6 | 35 | 35 | 30 | — | 70 | — | 30 |
| P7 | 45 | 30 | 25 | — | 55 | — | 45 |
| P8 | 50 | 20 | — | 30 | 80 | — | 20 |
| P9 | 15 | 65 | 20 | — | 55 | 45 | — |
| P10 | 15 | 65 | 20 | — | 55 | 30 | 15 |
| P11 | 15 | 65 | 20 | — | 55 | — | 45 |
| P12 | — | — | — | 100 | 85 | 15 | — |

### <Preparation of Polyimide Film>

Hereinafter, a method of preparing a polyimide film (specifically, a non-thermoplastic polyimide film and a multi-layered polyimide film) in each of Examples 1 to 6 and Comparative Examples 1 to 5 will be described.

### Example 1

### (Preparation of Non-Thermoplastic Polyimide Film)

To 60.0 g of the solution P1, 24.0 g of an imidization accelerator composed of AA/IQ/DMF (weight ratio: AA/IQ/DMF=8.06/3.77/12.17) was added to prepare a dope solution. Subsequently, the dope solution was defoamed while stirred in an atmosphere at a temperature of 0° C. or lower, and then the dope solution was applied onto an aluminum foil with a Comma Coater to form a coating film. Subsequently, the coating film was heated under the condition of a heating temperature of 110° C. for 150 seconds to obtain a self-supporting gel film. The obtained gel film was peeled off from the aluminum foil, fixed to a metallic fixation frame, heated under the condition of a heating temperature of 250° C. for 17 seconds, and subsequently heated under the condition of a heating temperature of 350° C. for 70 seconds, and thus dried and imidized to obtain a non-thermoplastic polyimide film (non-thermoplastic polyimide film of Example 1) having a thickness of 17.0 μm.

### (Preparation of Multi-Layered Polyimide Film)

To 60.0 g of the solution P1, 24.0 g of an imidization accelerator composed of AA/IQ/DMF (weight ratio: AA/IQ/DMF=8.06/3.77/12.17) was added to prepare a dope solution (hereinafter, referred to as “dope solution D1”). Subsequently, the dope solution D1 was defoamed while stirred in an atmosphere at a temperature of 0° C. or lower. Subsequently, the solution P12, the dope solution D1, and the solution P12 were each applied onto an aluminum foil in this order with a Comma Coater to form a coating film having a three-layer structure. Subsequently, the coating film was heated under the condition of a heating temperature of 120° C. for 200 seconds to obtain a self-supporting gel film. The obtained gel film was peeled off from the aluminum foil, fixed to a metallic fixation frame, heated under the condition of a heating temperature of 250° C. for 17 seconds, and subsequently heated under the condition of a heating temperature of 350° C. for 70 seconds, and thus dried and imidized to obtain a multi-layered polyimide film (multi-layered polyimide film of Example 1) having a three-layer structure including a thermoplastic polyimide layer (thickness: 4.0 μm), a non-thermoplastic polyimide layer (thickness: 17.0 μm), and a thermoplastic polyimide layer (thickness: 4.0 μm).

### Examples 2 to 6 and Comparative Examples 1 to 5

A polyimide film (specifically, a non-thermoplastic polyimide film and a multi-layered polyimide film) of each of Examples 2 to 6 and Comparative Examples 1 to 5 was obtained by the same method as in Example 1 except that the kind of the solution (non-thermoplastic polyamic acid solution) was changed as shown in Table 3. In each of Examples 2 to 6 and Comparative Examples 1 to 5, the amount of the non-thermoplastic polyamic acid solution used in preparation of the non-thermoplastic polyimide film or the multi-layered polyimide film was 60.0 g.

### <Results>

Table 3 shows the kind of the used solution (non-thermoplastic polyamic acid solution), the physical properties of the non-thermoplastic polyimide film, and the evaluation result of the desmear liquid resistance of the multi-layered polyimide film in each of Examples 1 to 6 and Comparative Examples 1 to 5.

TABLE 3

| | | Physical properties of non-thermoplastic polyimide film | | | | | Desmear |
|---|---|---|---|---|---|---|---|
| | | | Stress at | Inclination of | | | liquid |
| | | Tensile | 10% | plastic | | Desmear | resistance of |
| | | modulus | strain | deformation | CTE | liquid | multi-layered |
| | Solution | [GPa] | [MPa] | region | [ppm/K] | resistance | polyimide film |
| Example 1 | P1 | 7.4 | 226 | 2.11 | 11.9 | A | A |
| Example 2 | P2 | 7.8 | 246 | 2.08 | 11.3 | A | A |
| Example 3 | P3 | 8.6 | 252 | 2.43 | 7.0 | A | A |
| Example 4 | P4 | 8.7 | 249 | 2.30 | 6.6 | A | A |
| Example 5 | P5 | 10.6 | 301 | 2.30 | 7.8 | A | A |
| Example 6 | P6 | 9.1 | 257 | 2.01 | 7.6 | A | A |
| Comparative | P8 | 6.8 | 181 | 0.49 | 11.0 | C | C |
| Example 1 | | | | | | | |
| Comparative | P9 | 6.6 | 210 | 2.32 | 10.4 | B | B |
| Example 2 | | | | | | | |
| Comparative | P10 | 6.7 | 217 | 2.08 | 10.1 | B | B |
| Example 3 | | | | | | | |
| Comparative | P11 | 6.7 | 216 | 1.81 | 13.3 | B | B |
| Example 4 | | | | | | | |
| Comparative | P7 | 9.3 | 253 | 1.27 | 7.1 | B | B |
| Example 5 | | | | | | | |

In the multi-layered polyimide film of each of Examples 1 to 6, the non-thermoplastic polyimide contained in the non-thermoplastic polyimide layer had a BTDA residue, which is a kind of BENDA residue, and an m-TB residue, which is a kind of BPDI residue. In the non-thermoplastic polyimide layer in each of Examples 1 to 6, the content rate of the BPDI residue was 30 mol % or more and 100 mol % or less with respect to all of diamine residues included in the non-thermoplastic polyimide layer. The non-thermoplastic polyimide contained in the non-thermoplastic polyimide layer in each of Examples 1 to 6 was a block copolymer having a specific segment.

As shown in Table 3, in Examples 1 to 6, the evaluation result of the desmear liquid resistance of the multi-layered polyimide film was A. Therefore, the multi-layered polyimide films of Examples 1 to 6 achieved suppression of reduction in film strength caused by a desmear treatment.

In the multi-layered polyimide film of Comparative Example 1, the non-thermoplastic polyimide contained in the non-thermoplastic polyimide layer did not have a BPDI residue. In the multi-layered polyimide film of Comparative Example 2, the non-thermoplastic polyimide contained in the non-thermoplastic polyimide layer did not have a BENDA residue. In the non-thermoplastic polyimide layer in each of Comparative Examples 2 to 5, the content rate of the BPDI residue was less than 30 mol % with respect to all of diamine residues included in the non-thermoplastic polyimide layer.

As shown in Table 3, in Comparative Examples 1 to 5, the evaluation result of the desmear liquid resistance of the multi-layered polyimide film was B or C. Therefore, the multi-layered polyimide films of Comparative Examples 1 to 5 did not achieve suppression of reduction in film strength caused by a desmear treatment.

From the above results, it has been shown that the multi-layered polyimide film according to one or more embodiments of the present invention can suppress reduction in film strength caused by a desmear treatment.

### DESCRIPTION OF REFERENCE SIGNS

10 multi-layered polyimide film
11 non-thermoplastic polyimide layer
12 thermoplastic polyimide layer
13 metal layer
20 metal-clad laminate

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A multi-layered polyimide film comprising:
a non-thermoplastic polyimide layer, and
one or more thermoplastic polyimide layers disposed on at least one surface of the non-thermoplastic polyimide layer,
wherein the non-thermoplastic polyimide layer contains a non-thermoplastic polyimide containing:
a tetracarboxylic dianhydride residue including a benzophenone skeleton, as a tetracarboxylic dianhydride residue; and
a diamine residue including a biphenyl skeleton, as a diamine residue, and
the multi-layered polyimide film has a content rate of the diamine residue including a biphenyl skeleton of 30 mol % or more and 100 mol % or less with respect to all of diamine residues included in the non-thermoplastic polyimide.

2. The multi-layered polyimide film according to claim 1, wherein a content rate of the tetracarboxylic dianhydride residue including the benzophenone skeleton is 30 mol % or more and 100 mol % or less with respect to all of tetracarboxylic dianhydride residues included in the non-thermoplastic polyimide.

3. The multi-layered polyimide film according to claim 1, wherein a strain retention rate is 80% or more after the non-thermoplastic polyimide layer is subjected to a desmear treatment under conditions of a treatment temperature of 70° C. and a treatment time of 5 minutes.

4. The multi-layered polyimide film according to claim 1, wherein the non-thermoplastic polyimide layer at 10% strain has a tensile stress of 220 MPa or more.

5. The multi-layered polyimide film according to claim 1, wherein the non-thermoplastic polyimide layer has a linear thermal expansion coefficient of 5.0 ppm/K or more and 19.0 ppm/K or less.

6. A metal-clad laminate comprising:
the multi-layered polyimide film according to claim 1; and
a metal layer disposed on a main surface of at least one of the one or more thermoplastic polyimide layers of the multi-layered polyimide film.
